(19) United States
(12) Patent Application Publication
(10) Pub. No.: US 2006/0143013 A1
(43) Pub. Date: Jun. 29, 2006

(54) Method and system for playing audio at an accelerated rate using multiresolution analysis technique keeping pitch constant

(75) Inventor: Manoj Kumar Singhal, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/022,754

(22) Filed: Dec. 28, 2004

(51) Int. Cl. G10L 13/00

(52) U.S. Cl. 704/265

(57) ABSTRACT

A signal processing unit for playing back an audio signal at an accelerated rate keeping pitch constant. The audio signal is at least one of a speech signal, a pure music or an audio signal which comprises of both speech and music signal. The signal processing unit comprises a plurality of bandpass filters with each of them receiving a first plurality of samples of the audio signal, a plurality of decimators and an adder. The plurality of bandpass filters generate a second set of plurality of samples after passing the first plurality of samples of the audio signal through each of them. The plurality of bandpass filters have different pass bands, different stop bands, and a constant Q factor. The plurality of decimators are connected to the plurality of bandpass filters and generate a third set of plurality of samples. The plurality of bandpass filters and the plurality of decimators correspond in number. The adder superimposes constituents of the third set of plurality of samples generated by the plurality of decimators. The adder outputs a fourth plurality of samples which on playing gives rise to an accelerated version of the audio signal having a pitch which is consistent with a pitch of the audio signal in a non-accelerated condition.

### BACKGROUND OF THE INVENTION

1. Field of the Invention

The present invention relates to a method and apparatus for playing back an audio signal at an accelerated rate by a signal processing unit and simultaneously keeping pitch of the audio signal constant using multiresolution analysis technique.

2. Description of the Related Art

A signal can be viewed as composed of a smooth background and fluctuations or details on top of it. The distinction between the smooth part and the details is determined by the resolution. At a given resolution, a signal is approximated by ignoring all fluctuations below that scale. The resolution can be progressively increased; at each stage of the increase in resolution finer details being added to the coarser description, providing a successively better approximation to the signal. Eventually when the resolution goes to infinity, the exact signal is recovered. Multiresolution refers to the simultaneous presence of different resolutions.

Systems are available in the market, which enable users to play back an audio signal at an accelerated rate. The audio signals that are typically played back at accelerated rates can be a speech signal, a music recording and an audio data signal. However in none of the available systems does the pitch of the audio signal remain constant when it is played back at an accelerated rate.

Typically, when an audio signal is played back at a faster rate than the rate at which it is sampled, the pitch of the output audio signal is typically different than that of the original signal. Thus, sound quality deteriorates as it is played faster. There are no known audio systems that can handle this problem.

There may be several reasons for playing an audio signal at a rate that is faster than its sampling rate during audio signal capture or recording. However, the playback at a faster rate is often unpleasant if not a strange version of the original that sounds significantly different than the original.

### SUMMARY OF THE INVENTION

The object of this invention is to overcome the drawbacks of the above-mentioned conventional audio systems and methods. The present invention is directed to methods and systems for playing back an audio signal at an accelerated rate that obviate one or more problems of the art.

By way of example, a plurality of bandpass filters with different pass bands and stop bands but same Q factor are used. A first plurality of samples of the audio signal are passed through each of the plurality of bandpass filters. The plurality of bandpass filters extract the audio signal with different resolutions; coarse resolution to very fine resolution. Output of each of the plurality of bandpass filters is communicatively connected with only one of a plurality of decimator. At outputs of the plurality of decimators, downsampled versions of the audio signal with different resolutions are available. An adder superimposes samples available at outputs of the plurality of decimators, thereby generating an accelerated version of the audio signal but also recovering the characteristics of the audio signal.

The first plurality of samples of the audio signal are passed through each of a plurality of bandpass filters, which generate a second set of plurality of samples at their outputs. A plurality of decimators are communicatively connected to the outputs of the plurality of bandpass filters. The plurality of decimators generate a third set of plurality of samples after passing the second set of plurality of samples generated by the plurality of bandpass filters through them. The constituents of the third set of plurality of samples are superimposed in an adder on a sample by sample basis and thus giving rise to a fourth plurality of samples. The fourth plurality of samples are played and the playing generates an accelerated version of the audio signal having a pitch which is consistent with a pitch of the audio signal in a non-accelerated condition.

The first plurality of samples of the audio signal is obtained by sampling the audio signal at a sampling rate. The sampling rate depends on a nature of the audio signal. The audio signal can be one of a speech signal, a pure music signal or an audio data signal which is combination of both speech and music signal. The accelerated rate at which the audio signal is to be played back and a number of the first plurality of samples of the audio signal determine a number of the fourth plurality of samples.

A method and system of playing back the audio signal at an accelerated rate has a plurality of subunits connected in parallel. There is at least a bandpass filter and a decimator in each of the plurality of subunits. Number of the plurality of subunits to be connected in parallel is determined by inspecting at least the sampling frequency of the audio signal, the accelerated rate at which the audio signal is to be played back and an interference introduced by bandpass filters provided in the plurality of subunits.

These and other objects of the present invention will be described in or be apparent from the following description of the preferred embodiments.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 is a schematic block diagram illustrating one embodiment of a signal processing unit for playing back an audio signal at an accelerated rate with accelerated version of the audio signal having a pitch which is consistent with a pitch of the audio signal in a non-accelerated condition.

FIG. 2 is a schematic block diagram illustrating another embodiment of the signal processing unit for playing back an audio signal at an accelerated rate with accelerated version of the audio signal having a pitch which is consistent with a pitch of the audio signal in a non-accelerated condition.

FIG. 3 is a flowchart illustrating an example of a method for playing back an audio signal at an accelerated rate with accelerated version of the audio signal having a pitch which is consistent with a pitch of the audio signal in a non-accelerated condition.

### DETAILED DESCRIPTION OF THE PREFERRED EMBODIMENT(S)

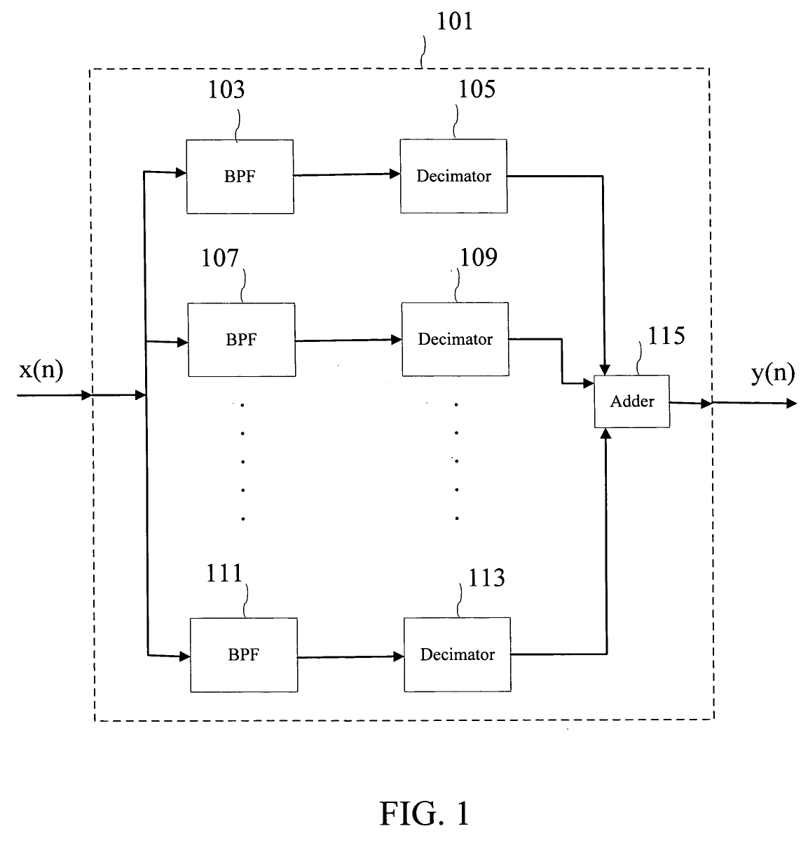

FIG. 1 is a schematic block diagram illustrating one embodiment of a signal processing unit for playing back an audio signal at an accelerated rate. x(n) is a first plurality of samples of the audio signal obtained by sampling the audio signal at a sampling frequency. The sampling frequency depends on a nature of the audio signal. The audio signal can be, for example, a speech signal, a pure music or an audio data signal which can be combination of both speech and music. The signal processing unit 101 processes the audio signal in time domain. The signal processing unit 101 has a plurality of bandpass filters, 103, 107, 111, a plurality of decimators 105, 109, 113 and an adder 115. Each of the plurality of bandpass filters, 103, 107, 111 receive the first plurality of samples of the audio signal, x(n). The plurality of bandpass filters, 103, 107, 111 have different pass bands and different stop bands. Q factor of a bandpass filter is ratio of its center frequency to a width of the passband of the filter. The plurality of bandpass filters, 103, 107, 111 have a constant Q factor. The plurality of bandpass filters, 103, 107, 111 generate a second set of plurality of samples after passing x(n) through each of them. Constituents of the second set of plurality of samples are samples generated by each of the plurality of bandpass filters 103, 107, 111. The first plurality of samples of the audio signal, x(n), is a fixed number of samples, where the number of samples in x(n) is decided in the beginning depending upon a nature of the audio signal and the sampling frequency. The constituents of the second set of plurality of samples have each the same number of samples as in x(n). The plurality of decimators 105, 109, 113 are communicatively coupled to outputs of the plurality of bandpass filters, 103, 107, 111. The plurality of bandpass filters and the plurality of decimators correspond in number. One of the plurality of decimators, 105, 109, 113 is communicatively coupled to an output of only one of the plurality of bandpass filters, 103, 107, 111. The decimator 105 is communicatively coupled to an output of the bandpass filter 103, the decimator 109 is communicatively coupled to an output of the bandpass filter 107, the decimator 113 is communicatively coupled to an output of the bandpass filter 111. The plurality of decimators 105, 109, 113 generate a third set of plurality of samples. Samples generated by the bandpass filter 103, which is a constituent of the second set of plurality of samples, pass through the decimator 105 and the decimator 105 retains at least one of the samples passing through it and drop a remainder of the samples. The retained samples are a constituent of the third set of plurality of samples. Hence the number of samples generated by each of the plurality of decimators 105, 109, 113 at their outputs is less than the number of samples in x(n). The plurality of decimators 105, 109, 113 employ different decimation techniques. Decimation technique employed by the decimator 105 depends on the pass band and the stop band of the bandpass filter 103, that employed by the decimator 109 depends on the pass band and the stop band of the bandpass filter 107, and so on. The adder 115 superimposes constituents of the third set of plurality of samples generated by the plurality of decimators 105, 109, 113 on a sample by sample basis. Superimposition is carried out in time domain. The adder outputs a fourth plurality of samples, y(n). Each of the constituents of the third set of plurality of samples and y(n) have identical number of samples in them. Thus number of samples in y(n) is less than the number of samples in x(n). Hence on playing y(n), an accelerated version of the audio signal is obtained. The bandpass filters 103, 107, 111 and the decimators 105, 109, 113 are so chosen that the accelerated version has a pitch which is consistent with a pitch obtained after playing x(n). Pitch of the accelerated version is consistent with the pitch of the audio signal in a non-accelerated condition.

In one embodiment of the present invention, x(n) is, for example, two hundred and fifty six number of samples of the audio signal and the audio signal is played back at an accelerated rate of two. The constituents of the second set of plurality of samples in the said embodiment are thus each two hundred and fifty six in number. The constituents of the third set of plurality of samples in the said embodiment will be each 256/2=128 (one hundred and twenty eight) number of samples. The plurality of decimators 105, 109, 113 employ different decimation techniques. The decimation techniques employed by the plurality of decimators in the said embodiment may be as follows. The decimator 105 retains the first one hundred and twenty eight samples passing through it and drops the last one hundred and twenty eight samples. Thus the number of samples generated at an output of the decimator 105 is one hundred and twenty eight. The decimator 109 divides the two hundred and fifty six samples into four groups of sixty four samples each. It retains the first sixty four samples passing through it and drops the next sixty samples. It retains the third group of sixty four samples and drops the fourth group of sixty four samples. Hence the number of plurality of samples generated at an output of the decimator 109 is one hundred and twenty eight. The decimator 113 divides the two hundred and fifty six samples into one hundred and twenty eight groups of two samples each. It retains every alternate group of two samples and drops the rest of the samples. Number of plurality of samples generated at an output of the decimator 113 is also one hundred and twenty eight. In the embodiment of the invention discussed above, the adder 115 superimposes one hundred and twenty eight samples generated by each of the plurality of decimators 105, 109, 113. y(n) is thus one hundred and twenty eight samples available at an output of the signal processing unit 101. x(n) is two hundred and fifty six number of samples of the audio signal. Hence on playing y(n), an accelerated version of the audio signal is obtained.

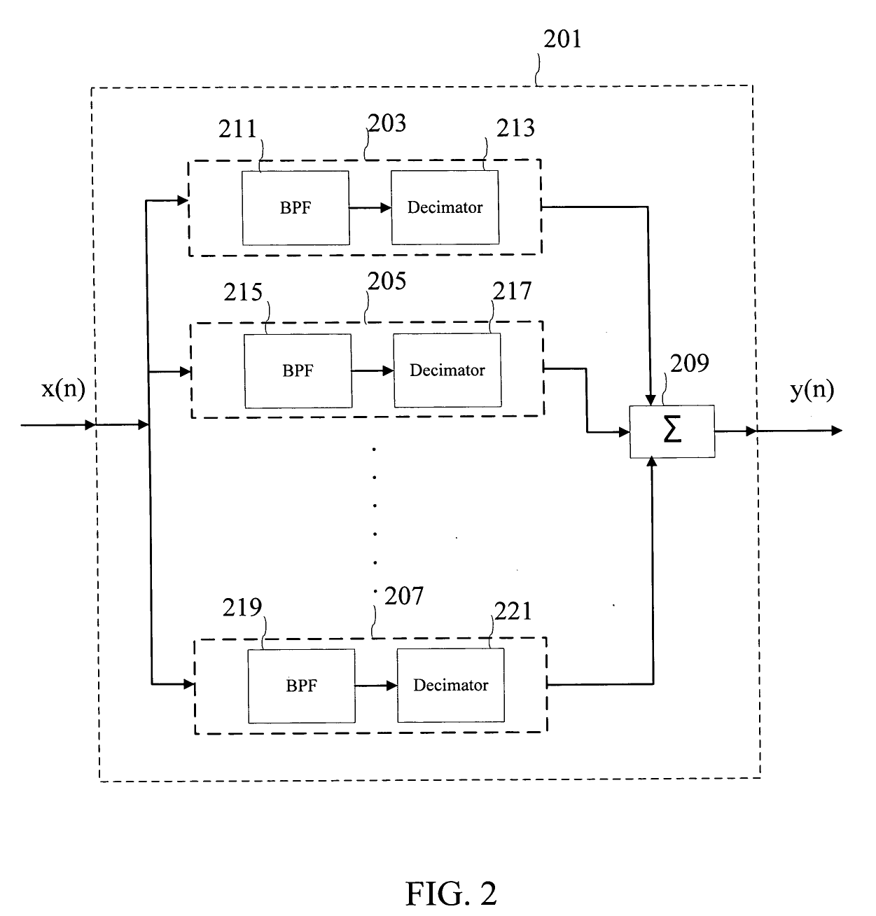

FIG. 2 is a schematic block diagram illustrating another embodiment of a signal processing unit for playing back an audio signal at an accelerated rate. The signal processing unit 201 has a plurality of subunits connected in parallel. There is at least a bandpass filter and a decimator communicatively connected to the bandpass filter in each of the plurality of subunits 203, 205, 207. The subunit 203 has a bandpass filter 211 and a decimator 213 communicatively connected to the bandpass filter 211. The subunit 205 has a bandpass filter 215 and a decimator 217. The subunit 207 has a bandpass filter 219 and a decimator 221. The bandpass filters 211, 215, 219 have different pass bands and a constant Q factor. The decimators 213, 217, 221 employ different decimation techniques. Decimation technique employed in a decimator depends at least on a pass band and a stop band of the bandpass filter to which it is communicatively connected. Decimation technique employed by the decimator 213 depends at least on a pass band and a stop band of the bandpass filter 211, decimation technique employed by the decimator 217 depends at least on a pass band and a stop band of the bandpass filter 215 and so on. x(n) is a first plurality of samples of the audio signal obtained by sampling the audio signal at a sampling frequency. The sampling frequency depends on a nature of the audio signal. The audio signal can be, for example, a speech signal, a pure music or an audio data signal which can be combination of both speech and music. The first plurality of samples of the audio signal is passed through each of the plurality of subunits. The plurality of subunits generate a second set of plurality of samples after passing the first plurality of the samples of the audio signal through them. A number of the plurality of subunits 203, 205, 207 to be connected in parallel depends at least on the sampling frequency of the audio signal, the accelerated rate at which the audio signal is to be played back, the Q factor of the bandpass filters 211, 215, 219 and an interference introduced by the bandpass filters. The adder 209 superimposes constituents of the second set of plurality of samples on a sample by sample basis. The constituents of the second set of plurality of samples are samples generated by the plurality of subunits 203, 205, 207. Superimposing in time domain generates a third plurality of samples, y(n). Number of samples in y(n) is less than number of samples in x(n). When y(n) is played, it generates an accelerated version of the audio signal. Determination of how many of the plurality of subunits to be connected in parallel and selection of the bandpass filters 211, 215, 219 and the decimators 213, 217, 221 are aimed at maintaining pitch of the accelerated version of the audio signal consistent with a pitch of the audio signal in a non-accelerated condition.

By way of example, an audio signal is to be played back at an accelerated rate of two. Suppose, x(n) is two hundred and fifty six number of samples of the audio signal. x(n) is passed through each of the plurality of subunits, 203, 205, 207. The plurality of subunits generate a second set of plurality of samples after passing x(n) through them. The constituents of the second set of plurality of samples in the present embodiment are each 256/2=128 number of samples. In other words, number of samples present at outputs of each of the plurality of subunits 203, 205, 207 is one hundred and twenty eight. Number of samples in y(n), output of the adder, is again one hundred and twenty eight in the present embodiment. On playing y(n), a two times accelerated version of the audio signal is obtained.

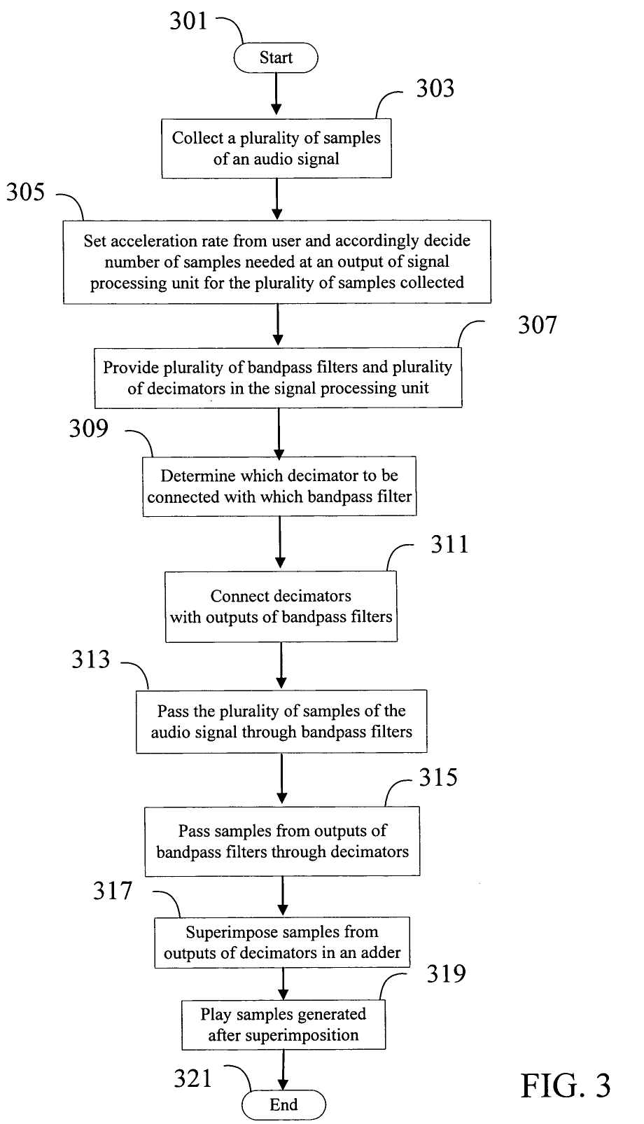

FIG. 3 is a flowchart illustrating an example of a method for playing back an audio signal at an accelerated rate by a signal processing unit. The process of playing an audio signal at an increased rate starts at the block 301. Then, at block 303, the signal processing unit collects a first plurality of samples of the audio signal. The first plurality of samples of the audio signal are obtained by sampling the audio signal at a sampling frequency. The sampling frequency depends on a nature of the audio signal. The audio signal can be a speech signal, a pure music or an audio data signal which can be combination of both speech and music. In block 305, the signal processing unit sets an acceleration rate supplied by the user. It accordingly determines a number of samples to be generated at its output. The number of samples to be generated at output of the signal processing unit is number of collected samples of the audio signal divided by the acceleration rate.

The signal processing unit has a plurality of bandpass filters, a plurality of decimators and an adder. In block 307, the plurality of bandpass filters and the plurality of decimators are provided. The number of bandpass filters in the signal processing unit depends at least on the acceleration rate, the sampling frequency and an interference introduced by the plurality of bandpass filters. Q factor across the plurality of bandpass filters is kept constant. Pass bands and stop bands of the plurality of bandpass filters are designed to be different.

The plurality of decimators and the plurality of the bandpass filters correspond in number. Decimation technique employed by each of the plurality of decimators is different. The decimation technique employed in a decimator can include retaining at least one of a plurality of samples passing through the decimator and dropping the rest of the plurality of samples. The determination of which of the plurality of bandpass filters is to be connected with which of the plurality of decimators is done at the next block 309. Such a determination comprises inspecting a pass band and a stop band for each of the plurality of bandpass filters and inspecting the decimation technique for each of the plurality of decimators. The plurality of decimators are communicatively connected with outputs of the plurality of bandpass filters in block 311.

Block 313 illustrates that the first plurality of samples of the audio signal collected at block 303 are passed through each of the plurality of bandpass filters. The plurality of bandpass filters generate a second set of plurality of samples. In the next block 315, samples generated at an output of each of the plurality of bandpass filters is passed through the corresponding decimator to which the bandpass filter is connected. The plurality of decimators generate a third set of plurality of samples. Constituents of the third set of plurality of samples are superimposed in step 317 on a sample by sample basis, giving rise to a fourth plurality of samples. The fourth plurality of samples are played in step 319 generating an accelerated version of the audio signal. Actions described in blocks 305, 307, 309, 311, 313, 315 and 317 ensure that pitch of the accelerated version of the audio signal is consistent with a pitch of a non-accelerated version of the audio signal. The process ends at block 321.

The above-discussed embodiments of the invention are discussed for illustrative purposes only. It would be understood to a person of skill in the art that other embodiments and other configurations are possible, while still maintaining the spirit and scope of the invention. For a proper determination of the scope of the present invention, reference should be made to the appended claims.

We claim:

1. A method of playing back an audio signal at an accelerated rate, said method comprising:
collecting a first plurality of samples of an initial audio signal at a signal processing unit;
passing the first plurality of samples of the initial audio signal through each of a plurality of bandpass filters, wherein the plurality of bandpass filters are configured to generate a second set of plurality of samples at their outputs;
providing a plurality of decimators;
connecting the outputs of the plurality of bandpass filters with the plurality of decimators, wherein the plurality of decimators are configured to generate a third set of plurality of samples;
determining a number of a fourth plurality of samples to be generated at an output of the signal processing unit;
superimposing constituents of the third set of plurality of samples, said superimposing generates the fourth plurality of samples; and
playing the fourth plurality of samples as an audio signal.

2. The method according to claim 1, wherein the playing step comprises playing the accelerated audio signal with a pitch which is consistent with a pitch of the initial audio signal.

3. The method according to claim 1, wherein the passing the first plurality of samples comprises:
determining a number of the plurality of bandpass filters; and
calculating a pass band and a stop band for each of the plurality of bandpass filters.

4. The method according to claim 3, wherein the passing the first plurality of samples further comprises:
providing the plurality of bandpass filters with a constant Q factor.

5. The method according to claim 1, wherein providing the plurality of decimators comprises:
selecting a number of the plurality of decimators; and
determining a decimation technique for each of the plurality of decimators.

6. The method according to claim 5, wherein the decimation technique comprises:
retaining at least one of a plurality of samples passing through a decimator and dropping a remainder of the plurality of samples, wherein the retained samples become a constituent of the third set of plurality of samples.

7. The method according to claim 1, wherein the connecting comprises:
communicatively connecting at least one bandpass filter of the plurality of bandpass filters with the plurality of decimators; and
determining which of the plurality of bandpass filters to be communicatively connected with which of the plurality of decimators.

8. The method according to claim 7, wherein determining which of the plurality of bandpass filters to be communicatively connected with which of the plurality of decimators comprises:
inspecting the pass band and the stop band of each of the plurality of bandpass filters; and
inspecting the decimation technique employed by each of the plurality of decimators.

9. The method according to claim 1, wherein determining comprises:
dividing a number of the first plurality of samples of the initial audio signal by the accelerated rate at which the audio signal is to be played back.

10. A signal processing unit for playing back an audio signal at an accelerated rate comprising:
a plurality of bandpass filters receiving a first plurality of samples of the audio signal, said plurality of bandpass filters configured to generate a second set of plurality of samples after passing the first plurality of samples of the audio signal through each of them;
a plurality of decimators connected to at least one bandpass filter of the plurality of bandpass filters, said plurality of decimators configured to generate a third set of plurality of samples; and
an adder configured to superimpose constituents of the third set of plurality of samples generated by the plurality of decimators on a sample by sample basis,
wherein the adder outputs a fourth plurality of samples which when played generates an accelerated version of the audio signal having a pitch which is consistent with a pitch of the audio signal in a non-accelerated condition.

11. The signal processing unit according to claim 10, wherein:
the plurality of bandpass filters comprise different pass bands;
the plurality of bandpass filters comprise different stop bands; and
the plurality of bandpass filters have a constant Q factor.

12. The signal processing unit according to claim 10, wherein:
the plurality of decimators are communicatively coupled to outputs of the plurality of bandpass filters;
the plurality of bandpass filters and the plurality of decimators correspond in number; and
one of the plurality of decimators is communicatively coupled to an output of only one of the plurality of bandpass filters.

13. The signal processing unit according to claim 10, wherein:
the plurality of decimators employ different decimation techniques.

14. The signal processing unit according to claim 13, wherein:
each of the plurality of decimators retains at least one of a plurality of samples passing through it and drop a remainder of the plurality of samples, wherein the retained samples become a constituent of the third set of plurality of samples.

15. The signal processing unit according to claim 12, wherein:
which of the plurality of decimators to be communicatively coupled to the output of which of the plurality of bandpass filters is determined by inspecting the different pass bands and the different stop bands of the plurality of bandpass filters and inspecting the different decimation techniques employed by the plurality of decimators.

16. A method of playing back an audio signal at an accelerated rate, said method comprising:
providing a plurality of subunits connected in parallel;
providing at least a bandpass filter and a decimator in each of the plurality of subunits;
passing a first plurality of samples of the audio signal through the plurality of subunits, wherein the plurality of subunits are configured to generate a second set of plurality of samples after passing the first plurality of the audio signal through them; and
superimposing constituents of the second set of plurality of samples, said superimposing generating a third plurality of samples, wherein playing the third plurality of samples generates an accelerated version of the audio signal having a pitch which is consistent with a pitch of the audio signal in a non-accelerated condition.

17. The method according to claim 16, wherein providing the plurality of subunits comprises:
determining a pass band and a stop band for the bandpass filter in each of the plurality of subunits, wherein pass bands and stop bands across the plurality of subunits are different;
maintaining Q factors of bandpass filters constant across the plurality of subunits; and
determining different decimation techniques for decimators in the plurality of subunits.

18. The method according to claim 17, wherein:
decimation technique employed in a decimator depends at least on the pass band and the stop band of the bandpass filter to which it is communicatively connected.

19. The method according to claim 16, wherein:
determining the number of the plurality of subunits to be connected in parallel depends at least on a sampling frequency of the audio signal, the accelerated rate at which the audio signal is to be played back, Q factor of bandpass filters provided in the plurality of subunits and an interference introduced by them.

20. The method according to claim 16, wherein:
the audio signal is at least one of a speech signal, a pure music or an audio signal which comprises of both speech and music signal.
